(19) United States
(12) Patent Application Publication
(10) Pub. No.: US 2018/0272551 A1
(43) Pub. Date: Sep. 27, 2018

(54) DEVICE AND METHOD FOR CUTTING A FOOD PRODUCT STRAND

(71) Applicant: Uwe Reifenhaeuser, Flammersfeld (DE)

(72) Inventor: Uwe Reifenhaeuser, Flammersfeld (DE)

(73) Assignee: TPV GMBH, Oberlahr (DE)

(21) Appl. No.: 15/945,898

(22) Filed: Apr. 5, 2018

Related U.S. Application Data
(63) Continuation of application No. PCT/EP2016/073032, filed on Sep. 28, 2016.

(30) Foreign Application Priority Data
Oct. 5, 2015 (DE) DE102015116887.1

(51) Int. Cl. B26D 11/00; B26D 1/29; B26D 3/22; B26D 7/06; B26D 1/00

(52) U.S. Cl. CPC B26D 11/00; B26D 1/29; B26D 3/22; B26D 7/0608; B26D 2001/0046; B26D 1/0006; B26D 2210/02; B26D 2001/0033; B26D 7/0683

(57) ABSTRACT

The present invention relates to a method for cutting a food product, in particular a food product strand, into portions, in particular into strips or cubes, comprising the following method steps:
a) The food product is advanced to a cutting device (2) by means of an advancing device (12).
b) Successive portions are cut off from the food product from an end of the food product which faces the cutting device (2) by means of at least one cutting element (3), wherein the cutting element (3) is guided by means of a disc-shaped cutting element carrier (4), on which the cutting element (3) is arranged, wherein the cutting element carrier (4) is rotated about a drive axis (10) which is oriented at least substantially parallel to an advancing direction (7) of the advancing device (12).
c) During one-time guiding of the cutting element (3) past the end of the food product, a multiplicity of strip-shaped portions are produced. In order to provide a method, by means of which it is possible to produce cube-shaped portions in a particularly rapid manner, according to the invention the portions which are being produced are cut to size by means of at least one length cutting device (5) after the cutting by means of the at least one cutting element (3). The present invention further relates to a corresponding device.

### RELATED APPLICATIONS

This application is a continuation of reference International Patent Application PCT/EP2016/07032 filed on Sep. 28, 2016 and German Patent Application DE102015116887.1 filed on Oct. 5, 2015 and DE102018101972.6 filed on Jan. 30, 2018 both of which claims priority from and incorporates by

### FIELD OF THE INVENTION

The present invention relates to a method for cutting a food product, in particular a food product strand, into portions, in particular into strips or cubes, comprising the following method steps:

a) The food product is advanced to a cutting device (2) by means of an advancing device (12).

b) Successive portions are cut off from the food product from an end of the food product which faces the cutting device (2) by means of at least one cutting element (3), wherein the cutting element (3) is guided by means of a disc-shaped cutting element carrier (4), on which the cutting element (3) is arranged, wherein the cutting element carrier (4) is rotated about a drive axis (10) which is oriented at least substantially parallel to an advancing direction (7) of the advancing device (12).

c) During one-time guiding of the cutting element (3) past the end of the food product, a multiplicity of strip-shaped portions are produced. In order to provide a method, by means of which it is possible to produce cube-shaped portions in a particularly rapid manner, according to the invention the portions which are being produced are cut to size by means of at least one length cutting device (5) after the cutting by means of the at least one cutting element (3). The present invention further relates to a corresponding device.

The invention also relates to a device for cutting a food product, in particular a food product strand into portions, in particular strips or cubes, the cutting device comprising at least one feed device and at least one cutting device, wherein the food product is feed able by the feed device in a feed direction towards the cutting device, so that successive portions are cut able by the cutting device from an end of the food product that is oriented towards the cutting device, and wherein the cutting arrangement includes at least one cutting case which includes at least one transversal cutting edge and a plurality of longitudinal cutting edges wherein the transversal cutting edge is arranged in a first cutting plane that is oriented at least essentially parallel to a cutting surface of the food product, wherein the longitudinal cutting edges are respectively arranged in cutting planes that are not oriented parallel to the cutting plane of the transversal cutting edge, so that the food product is cut able during cutting in at least 2 cutting planes that are oriented in different directions, wherein the cutting case is rotate able about a drive axis which is at least essentially advantageously completely oriented parallel to the feed direction.

A cube compared to a strip is a piece of a food strand whose edge lengths are at least essentially identical.

A “cutting arrangement” according to the invention designates any arrangement that is configured to cut a food product or a food product strand into pieces. A cutting arrangement can include in particular at least one cutting device and a blade box which encloses for example the cutting device.

It is also conceivable that the cutting arrangement is formed exclusively by a cutting device.

A “cutting element” according to the instant invention is an element that actually cuts the food product or an element that is in cutting engagement with the food product. A cutting element of this type typically includes at least one cutting edge that is moved relative to the food strand so that the food product and the cutting edge come into cutting engagement with each other.

A portion according to the instant invention is a piece that is cut off from the original food product and that is move able independently from the other pieces or portions. Put differently an individual portion is completely cut off from the other portions and from the food product.

A “strip” shaped portion designates a portion whose length significantly exceeds its other dimensions. A typical strip therefore generally has a length which exceeds a width and height of the strip at least by a factor of 2, advantageously by a factor of 4.

Successive cut off according to the instant application is a cut off which is performed over and over again continuously, this means that portions that are successively cut off from the food strand are produced one after another and typically by repeated use of the same cutting element.

A “cutting box” according to the instant application is an element which combines a plurality of different cutting edges in one component. According to the instant invention a cutting box includes at least one transversal cutting edge and a plurality of longitudinal cutting edges. Transversal cutting edges and longitudinal cutting edges differ from each other in that they are oriented differently. Thus the longitudinal cutting edge are arranged in non-parallel cutting planes to the at least one transversal cutting edge. However the longitudinal cutting edges as well as also at least one transversal cutting edge are combined into at least one cutting box.

The cutting planes according to the instant invention are characterized in that food product is cut in them by cutting edges. Since the at least one cutting box includes a plurality of cutting edges the food product is cut or cut able into at least two cutting planes, wherein the cutting plates are oriented differently.

A disc shape according to the instant invention is a shape whose thickness is significantly smaller than its diameter or edge length. It is appreciated that this can be in particular circular slices. The disc shaped configuration of the cutting edge carrier and its rotation about a drive axis that is parallel to the feed direction causes the food product to be cut at its end that is oriented towards the cutting arrangement in a flat cutting plane which is oriented at least essentially parallel to the feed direction of the food product. The at least essentially parallel orientation between the drive axis of the cutting element carrier and the feed direction of the food product means according to the instant invention that an angle deviation between both axes is at the most 10°, advantageously at the most 5° ideally 0°.

### BACKGROUND OF THE INVENTION

Methods and devices of the general type recited supra are known in the art they are used in particular to cut food strands into slices which are formed by meat sausage or vegetables.

In particular so called strip slicers are known in the art by which strip shaped portions are separable from a food strand for example Machinenbau GmbH offers a strip cutter designated type BS 28 which includes a plurality of cutting boxes. The cutting boxes respectively include a plurality of cutting edges and a transversal cutting edge that is oriented perpendicular to the longitudinal cutting edges. The cutting boxes are arranged at a circular cutting element carrier so that so that they are rotate able about a rotation axis. They are run along a food product that is to be cut up so that success able strips are cut able from the food product. A strip cutter of this type can be derived for example from the German application publication DE102005050041 B3. Thus the transversal edge as well as the longitudinal edges come into cutting contact with the food product when each individual cutting box is run by the food product so that the food product is cut in several cutting planes simultaneously. On a side of the cutting box that is oriented away from the food product the individual cut strip shaped portions exit from the cutting box after the food product is cut. The known device has the disadvantage that the portions generated are only cut into planes that are linear independent from each other so that only strips are generate able. In particular it is not possible with the known device to also cut cubes or strips of a defined length. A length of the generated strips however is primarily a function of a path length by which the respective cutting box is run along the food product.

In the general field of the invention a device is known from the International Patent application published as WO 01/33940 A1 which device is configured to cut cubes. For this purpose the device includes a second cutting arrangement which is arranged in the feed direction of the food product behind the first cutting arrangement. The second cutting arrangement cuts produced strips of the food product to length, this means it cuts the strips in another linear independent cutting plane. This facilitates to produce cubes with the known device. The recited patent application however is only remotely related to the device and method according to the invention since the device does not include cutting boxes according to the preceding definition and is consequently not capable to produce a plurality of strip shaped portions by running the cutting element past the food product only once. Accordingly the device has the disadvantage to produce portions sequentially and therefore with lower performance than the strip cutter described supra.

Last not least the German patent document DE 10 2005 050 041 B3 discloses a cube cutter that relates to the wider field of the instant invention. The introduced device includes 2 drum shaped cutting arrangements that are supported inside one another to rotate about an axis that is perpendicular to a feed direction of the food product.

The cutting arrangement cuts successive portions from an end of the food strand wherein the cutting is performed along a circular arc. The illustrated type of cutting is disadvantageous since a rather large amount of scrap material is produced at a beginning and at an end of each food strains which in turn reduces performance of the machine.

### BRIEF SUMMARY OF THE INVENTION

Thus, it is an object of the instant application to provide a device and a method which facilitate producing portions at high speed which are especially parallel epiped.

Improving upon a method of the type described supra the object is achieved according to the invention in that portions that are being generated are cut to length after cutting by the at least one cutting element by at least one length cutting arrangement.

A length cutting arrangement according to the instant application is an arrangement which facilitates cutting a strip shaped portion another time so that its length is reduce able in particular it can be provided with a length cutting arrangement to generate strip shaped portions for example in that one or plural strip shaped portions are cut in another cutting plane that is linear independent from the other cutting planes. A length cutting arrangement of this type can include in particular at least one cutting edge which can be configured for example at a blade shaped element.

The cutting tool length after cutting the portion means according to the instant invention that an engagement of the at least one cutting element with the food product is performed time based before a cooperation of the length cutting arrangement with the portion that is being produced. Thus it is not mandatory that an engagement at least of a portion of the length cutting arrangement with a respective portion only occurs when the portion was already completely cut by the at least one cutting element. Instead it is also conceivable that a cutting engagement between the cutting element and the food product continues to exist while the length cutting arrangement comes in contact with the portion respectively formed. However there is a contact between the length cutting arrangement and a respective portion after a first contact of the portion with the at least one cutting element.

The method according to the invention has many advantages. First of all it has the substantial advantage that a plurality of at least initially strip shaped portions is generated simultaneously with moving the cutting element along the food product once. This method step causes a particularly time effective processing of the food product to be cut up. Thus it is particularly advantageous that the method according to the invention facilitates parallel epiped shaped, advantageously cuboid, further advantageously square portions at a high cyclic rate which is not possible in the art so far. Thus the individual portions are cut to length by the length cutting arrangement so that a plurality of cubic portions is produce able by running the cutting element along the food product once.

Furthermore it has proven particularly advantageous to perform the method according to the invention with a food product that is at least partially frozen, advantageously totally frozen. This method has the particular advantage that the individual portions can be produced with particularly high precision. In particular the generated cutting edges at the portions are “clean” since the increased hardness of the food product facilitates dedicated cut during which the food product deforms only slightly and accordingly does not have any distortions or similar.

In an advantageously embodiment of the method according to the invention a portion that is being produced is cut simultaneously at least at 3 cutting sides. In particular each portion is cut in at least one cutting plane which is oriented perpendicular to a feed direction of the food product. A cut in a cutting plane of this type can be produced particularly well by a cutting element of this type that has at least one transversal plane that is oriented perpendicular to the feed direction of the food product and which is supported perpendicular to the feed direction. Two additional cutting planes can be oriented for example perpendicular to the first cutting plane, wherein the cutting element advantageously includes longitudinal cutting edges which can be configured for example in turn perpendicular to a transversal cutting edge. Simultaneously cutting the food product at least at 3 cutting sides directly generates an at least strip shaped portion whose width and height is already defined by 3 cutting sides.

The term “cutting side” means in the context that cutting the at least one cutting element at a respective portion generates at least 3 cutting surfaces which are generated due to a direct engagement of the cutting element with the food product. The cutting surfaces thus generated are respectively configured at a cutting side of the respective portion.

The method according to the invention is furthermore particularly advantageous when the food product is advanced towards the cutting device incrementally. A feeding of this type is useful in particular when the food product provided in a partially frozen condition or completely frozen condition and therefore particularly hard, a continuous feeding of the food product would cause the food product to be pressed against components of the respective device continuously so that a dragging contact of a surface of the food product with the device and/or on the other hand side considerable forces are caused between the food product and the respective device. This is caused by the fact that a frozen food product is not compressible in the same way as a soft non-frozen food product.

Further configuring the method according to the invention the portions that are being produced are deflected during cutting so that a movement direction of a respective portion includes a movement component that is parallel to a feed direction of the food product. Typically the individual portions are cut from the food product to be cut by running the at least one cutting element along a cutting surface, wherein the cutting element is moved in a direction perpendicular to the feed direction of the food product.

The cutting surface of the food product is typically oriented perpendicular to the feed direction of the food product. The described deflection of at least one portion during cutting therefore describes a process where a movement direction is imparted upon a portion that is being produced, wherein the movement direction causes the portion to move away from the cutting surface of the food product, thus in a direction that extends at least partially parallel to the feed direction of the food product. This means that the deflection runs the at least one portion away from the cutting surface of the food product in a direction that is perpendicular to the cutting surface. It is appreciated that it is only required for this purpose that the portion receives a movement component during its deflection which movement component is orthogonal to the cutting surface of the food product. However it is not necessary but advantageous that a movement direction of the at least one portion after its deflection is completely parallel to the feed direction of the food product. The latter has the effect that so to speak a front cutting plane and a rear cutting plane of the formed portion are essentially oriented parallel to each other.

The described deflection of at least one portion advantageously of all portions has the essential advantage that the portions can be extracted so to speak in an extended direction of the food product on a side of the respective cutting element that is oriented away from the food product and can be collected thereafter. In particular it is conceivable that a collection container for the formed portions is placed in an extended direction of the food product or the associated feed arrangement in or at the device. Advantageously the portions are deflected directly by the cutting arrangement, advantageously by the cutting element. This way a separate device for deflecting the portions can be omitted.

Deflecting the portions is particular advantageously when this deflection is performed with a deflection angle of at least 70° advantageously at least 80° further advantageously of at least 90°. Considering the typical case that the cutting surface of the food product extends perpendicular to its feed direction a deflection of a respective portion by less than 90° has the consequence that a movement of the portion after its deflection has a movement component that is oriented parallel to the feed direction of the food product as well as a movement direction that is oriented perpendicular to the feed direction of the food product. A deflection by at least approximately 90° thus has the advantage that the portions thus deflected can be extracted from the cutting arrangement on a side of the cutting arrangement that is oriented away from the food product.

A deflection of the portions by an angle that is as large as possible (up to 90° at the most) furthermore has the advantage that the portions thus deflected can be cut to length by the at least one length cutting arrangement after being deflected. A method step of cutting the portions to length after deflection is independent from the respectively implemented deflection angle as a matter of principle.

Advantageously the length cutting arrangement includes a cutting plane that is oriented perpendicular to the feed direction of the food product. In particular the cutting plane of the length cutting arrangement can be oriented parallel to a cutting plane of the cutting arrangement or of the at least one cutting element. This way the length cutting arrangement or an associated length cutting edge can be run in a particularly simple manner along a side of the cutting arrangement or of the cutting element that is oriented away from the food product. Through the deflection it is then possible in a particularly simple manner to feed the generated portions or the portions that are being generated from the food product to the length cutting arrangement. A respective arrangement can be derived from embodiment recited infra. Ideally the length cutting arrangement is configured disc shaped, advantageously configured as a circular disc. It can be furthermore advantageous when the length cutting arrangement is rotated about a drive axis. Thus it is appreciated that in particular a combination of the cutting arrangement that rotates about its drive axis with a rotate able length cutting arrangement is particularly advantageous. It is conceivable in particular that the cutting arrangement and the length cutting arrangement are arranged behind one another in feed direction of the food product and respectively rotate about drive axes that are parallel to each other and advantageously identical. From a device engineering view implementing the method is particularly simple when the cutting arrangement and the length cutting arrangement have the same drive axes.

When the length cutting arrangement as well as the cutting arrangement are configured rotate able it can be particularly advantageous when the rotation directions of both arrangements are opposite to each other, so that a relative velocity by which the cutting arrangement and the length cutting arrangement are moved past each other corresponds to a sum of rotation velocities of both arrangements. This embodiment has the consequence that a velocity under which a length cutting edge of the length cutting arrangement collides with the portion when the length cutting arrangement comes in contact with a portion to be cut to length is comparatively large which helps to generate a particularly clean cut of the portion to be cut to length.

The method according to the invention is furthermore advantageous when at least a residual section of the food product is measured during the cutting of the food product and based on the data thus captured a feed of the food product and/or a cutting velocity of the cutting arrangement is adapted. A measurement can be performed for example by a laser scanner or by one or plural cameras. The described adaptation is performed in a manner so that a last cut of the cutting arrangement so that a last cut of the cutting arrangement at least essentially completely cuts an end piece of the food product and scrap is minimized this way.

“Residual section” is a section of the food product whose length that is measured parallel to the feed direction is less than a length of the entire original food product. In particular the length of a residual section is not more than 30% of the original length of the food product. It is advantageous for a success of this advantageous method step when only a residual section of the food product is measured is order to avoid left over material. By the same token it is also conceivable that the entire food product is measured before a first step and the feed and/or a cutting velocity of the cutting arrangement are adapted accordingly. The advantageous method step helps that no residual piece is left over after cutting up a respective food product is finished since the residual piece would have to be disposed of without being used. The residual piece thus helps that a respective food strand or a respective food product can be cut up completely.

From a device point of view the object is achieved according to the invention by at least one length cutting arrangement by which portions can be cut to length which were previously cut by the cutting arrangement. The cut of the length cutting arrangement eventually finishes the respective portions.

The method according to the invention can be practiced by the device according to the invention in a particularly simple manner. This applies in particular when the cutting boxes are arranged on a cutting element carrier that is supported to rotate about a drive axis. Furthermore the method is particularly simple in an advantageous embodiment when the length cutting arrangement is arranged on a side of the cutting arrangement that is oriented away from the uncut food product.

Advantageously the length cutting arrangement is configured as a rotate able advantageously circular length cutting disc. This way the advantageous method steps described supra can be performed in a particular simple manner. Advantageously a length cutting disc of the length cutting arrangement includes a plurality of length cutting edges. The length cutting edges are advantageously mounted on the length cutting disc so that a cutting plane of the respective length cutting edges is oriented parallel to a length cutting disc of the length cutting arrangement.

Advantageously the cutting arrangement is configured rotate able in addition to or as an alternative to the length cutting arrangement, wherein the cutting arrangement is formed in turn by a circular cutting disc. The cutting disc is particularly well suited as a cutting element carrier for the at least one cutting box.

When the length cutting arrangement as well as the cutting arrangement are configured rotate able it is advantageous when both of them are respectively rotate able about identical drive axes that are parallel to each other. It is furthermore advantageous when at least one of the drive axes of the length cutting arrangement and/or of the cutting arrangement, advantageously both drive axes are oriented parallel to the feed direction of the food product.

With respect to the configuration of the at least one cutting box it can be particularly advantageous when the cutting planes of the longitudinal cutting edges are configured at least substantially orthogonal to the cutting plane of the transversal cutting edge. This way portions are generate able that have a rectangular cross section. In particular it can be advantageous when at least one cutting box, advantageously all cutting boxes have a first transversal cutting edge that is oriented parallel to the cutting surface of the food product and a plurality of additional longitudinal cutting edges that are perpendicular to the transversal cutting edge and arranged parallel to each other adjacent to each other. Thus it is irrelevant as a matter of principle which of the cutting edges, this means the at least one transversal cutting edge or one or plural longitudinal cutting edges contact the food product to be cut first. Thus it is also conceivable that the longitudinal cutting edges protrude beyond the transversal cutting edge in a movement direction of the respective cutting box so that they enter the food product to be cut first when they engage the food product. By the same token also a reversed embodiment is conceive able.

Configuring the device according to the invention in more detail it or advantageously its cutting arrangement, further advantageously at least one cutting cassette of the cutting arrangement includes at least one support channel by which a portion is deflect able so that its movement direction after the deflection includes at least a movement component that is parallel to the feed direction of the food product. Thus it is irrelevant as a matter of principle whether the portion is still under production at the point of time of its deflection, already completed or whether it is completed during deflection. Put differently it is only relevant that a deflection of the respective portion can be performed by the described support channel.

Through the described support channel the previously described method steps for deflecting at least one portion can be performed in a particularly simple manner.

Thus it is particularly advantageous when a support channel of this type has a support length of at least 5 cm, advantageously at least 10 cm, further advantageously at least 15 cm. “Support length” in this context means a flattened length of the respective support channel.

The stated values are advantageous in that a respective movement clearance is given to the respective portion to be deflected so that the respective portion can follow a respective deflection angle. Put differently a longer support channel is well suited to softly deflect a portion that is being made, this means with a minimum curvature of the support shaft. This is important in particular when the food product is provided in a partially frozen or entirely frozen condition in which it has increased hardness. The advantages of cutting a hard food product have already been described supra.

A portion formed by a hard food product also has increased hardness so that deflecting a portion of this type has the risk that the portion breaks within the support channel and disintegrates into several pieces. A comparatively long configuration of the support channel facilitates distributing the respective deflection angle over a longer distance so that a curvature of the support channel is kept rather small. This reduces a fracture risk of a portion that is being made.

In this context it has proven particularly advantageous when a ratio of a width of a support channel to its flat length (support length) has a maximum value of 0.2, advantageously 0.1, further advantageously 0.067. A “width” of the support channel thus describes a distance of 2 adjacent longitudinal edges from each other. Typically the support channels respectively have a square cross section, wherein a typical dimension for a width of a support channel is 1 cm.

Advantageously the support channel has a circular arc shape. Independently of its shape the support channel has a deflection angle of at least 70°, advantageously at least 80°, further advantageously at least 90°. The advantageous method described supra can be performed in a particularly simple manner by the support channel.

In another advantageous embodiment of the device according to the invention the device includes at least one opposite cutting edge that is arranged on a side of the cutting arrangement that is oriented away from the uncut food product. An opposite cutting edge is configured to cooperate with the length cutting arrangement wherein a respective portion that is to be cut to length is support able at the opposite cutting edge.

Thus a distance between the cutting edge and the length cutting arrangement is advantageously variable. This has the advantage that the cutting arrangement and the length cutting arrangement are individually adaptable to each other for each device. In particular a distance between a length cutting edge of the length cutting arrangement and the opposite cutting edge of the cutting arrangement is small enough so that a collision of the length cutting arrangement with the cutting arrangement can occur due to fabrication tolerances in the production of the device.

By the same token it is conceivable that a distance between the opposite cutting edge of the cutting arrangement and a respective length cutting arrangement of the length cutting arrangement is too large ex works. The adaptability facilitates to adjust a distance between the length cutting arrangement and the opposite cutting edge in an optimum manner.

Advantageously the opposite cutting edge is configured directly at a respective cutting box, wherein the opposite cutting edge is configured at an end of the cutting box that is oriented away from the uncut food product. Advantageously each cutting box has its own cutting edge. For a clean cut of the respective food product it is particular advantageous when the food product is retained by the feed arrangement, this means does not allow any particular movement clearance for the food product due to cutting forces. Therefore it is particularly advantageous when the feed arrangement includes at least one fixing arrangement by which the uncut food product is fixable in the feed arrangement. A fixing arrangement of this type can include in particular and element that is move able transversal to the feed direction of the food product by which the food product is press able in a feed channel of the feed arrangement against an opposite side wall.

It can be furthermore advantageous when the device according to the invention includes at least one stop element that protrudes in the feed direction of the uncut food product over a cutting plane of the transversal cutting edge of the cutting box so that a section of the food product that is to be cut off is at least partially support able by the stop element. A stop element of this type is advantageous in particular when the food product to be cut has a comparatively soft consistency so that the food product deforms under cutting forces that are imparted upon the food product by a respective cutting box or its cutting edges. So that the food product moves away from the cutting edge. The stop element is used for supporting the section of the food product to be cut off against the cutting forces so that the food product cannot move away from the cutting box. Thus it is particularly advantageous when the stop element is arranged directly at a pass through opening of the feed arrangement where a cutting side of the uncut food product protrudes from the feed arrangement so that it can be cut by the cutting arrangement.

A stop element of this type is advantageously configured move able so that it can move away from the cutting arrangement or the at least one cutting box. This way a collision between the stop element and a respective cutting box can be prevented. Advantageously the stop element is configure with at least one spring which facilitates displacing the stop element in a direction that is parallel to the feed direction of the food product and subsequently moving it back into an extended position. This way the stop element of the cutting box can escape in a particularly simple manner. In particular the cutting arrangement can include a displacement arrangement by which the at least one stop element is displace able so that the described collision between the stop element and the cutting box is avoided. Advantageously the stop element is displaced so that it is only displaced in the moment where the cutting box passes the stop element and otherwise as stated supra protrudes beyond the feed arrangement so that it can support the uncut section of the food product.

### BRIEF DESCRIPTION OF THE DRAWINGS

Further advantages can be derived from the dependent patent claims, the description and the drawing figure, wherein:

FIG. 1 illustrates an exploded view of a device according to the invention;

FIG. 2 illustrates the device according to the invention according to FIG. 1 however from another viewing angle;

FIG. 3 illustrates a device according to the invention in a cross section that is supported parallel to a feed direction of the food product;

FIG. 4 illustrates a detail of a cutting arrangement and a length cutting arrangement of the device according to the invention in a cross sectional view;

FIG. 5 illustrates a detail of a cutting box of the device according to the invention;

FIG. 6 illustrates the cutting box according to FIG. 5 however in a cross sectional view;

FIG. 7 illustrates an alternative cutting box in a cross sectional view; and

FIG. 8 illustrates a cutting box arranged on a cutting element carrier.

### DETAILED DESCRIPTION OF THE INVENTION

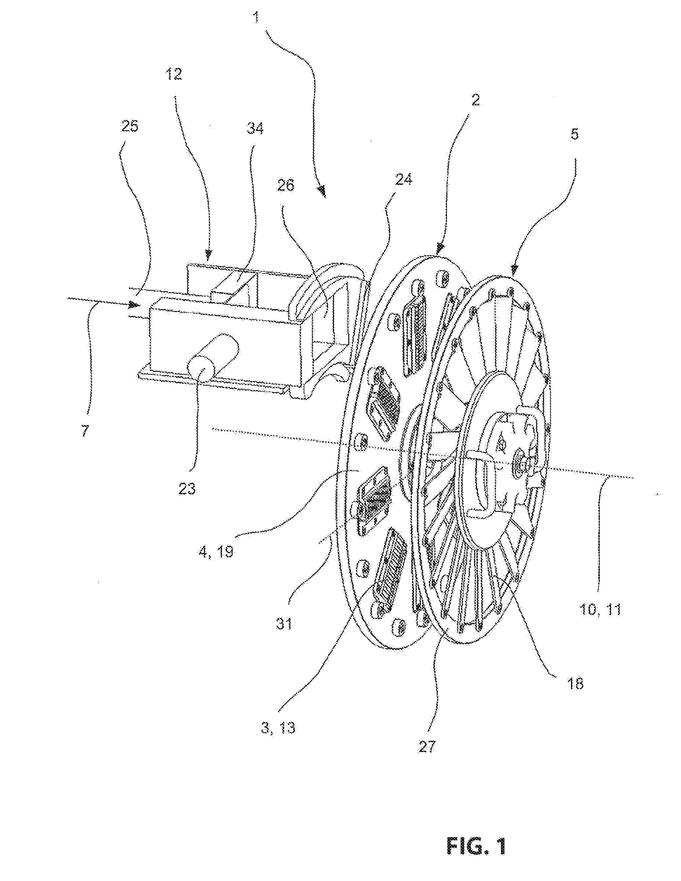

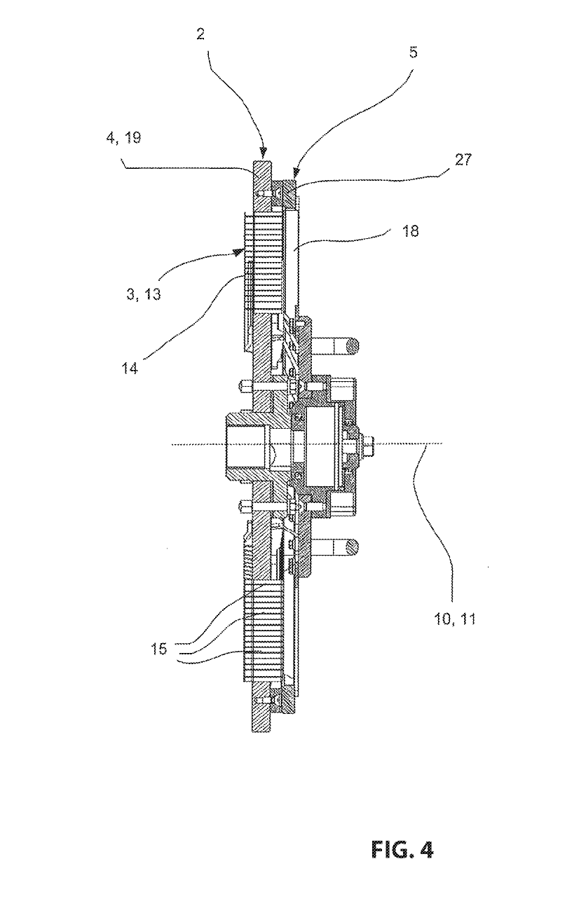

The embodiment that is illustrated in FIGS. 1-8 includes a device 1 according to the invention that includes a feed arrangement 12, cutting arrangement 2 and a length cutting arrangement 5. The feed arrangement 12 includes a product shaft in which a respective food product that is to be cut up is feed able into a feed direction 7. For this purpose the feed arrangement 12 includes a feed plunger 25 which pushes the respective food product from a side that is oriented away from the cutting arrangement 2 towards the cutting arrangement 2. Additionally the feed arrangement 12 includes a fixing arrangement 23 by which the food product is fixable laterally within the feed arrangement 12. The fixing arrangement 23 is formed by a side wall that is move able transversal to the feed direction 7 wherein the side wall is move able perpendicular to the feed direction 7 by a drive that is not illustrated. At a side that is oriented away from the food product the fixing arrangement 23 includes a cylindrical transmission element by which a drive force is transferable from the drive to the side wall.

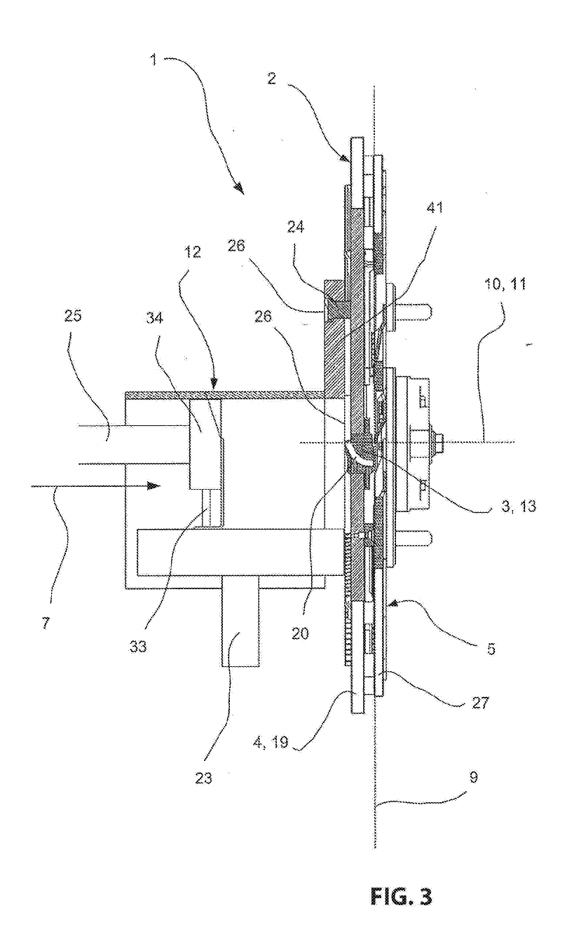

As evident in particular from FIG. 3 the feed plunger 25 includes a telescope portion 33 that is move able in a direction perpendicular to the feed direction 7 relative to the feed plunger 25. The telescope element 33 is thus configured so that it can move into a contact plate 34 of the feed plunger 25. This relative move ability of the telescope portion 33 facilitates clamping the fixing arrangement 23 relative to the feed direction 7 without binding the feed plunger 25. The feed arrangement 12 includes a pass through opening 26 at an end that is oriented towards the cutting arrangement wherein the food product is push able out of the feed arrangement 12 towards the cutting arrangement 2.

Proximal to the pass through opening 26 the feed arrangement 12 furthermore includes a stop element 24 in the illustrated embodiment the stop element is arranged on a left side of the pass through opening 26 relative to the feed direction 7. The stop element 24 is configured so that it protrudes axially beyond the remainder of the feed arrangement 12 viewed in the feed direction 7, so that a respective section of the food product to be cut that protrudes beyond the feed arrangement 12 is support able by the stop element 24. The arrangement of the stop element 24 already indicates that the cutting arrangement 2 which is subsequently described in detail is rotated counter clock wise in the feed direction 7. The stop element 24 is thus used to react cutting forces that are imparted upon the food product by the cutting arrangement 2 or by the cutting elements 3 of the cutting arrangement 2 and can be reacted into the feed arrangement 12.

In the illustrated embodiment the stop element 24 is provided with a spring mechanism so that the stop element 24 is move able parallel to the feed direction 7 and relative to the feed arrangement 12. Put differently the stop element 24 can be retracted. This move ability has the background that the stop element 24 should be configured to move away from a respective cutting element which is moved along the pass through opening 26 so that a collision between the cutting element and the stop element 24 is avoided. Ideally the respective cutting element or another component of the device 1 includes a displacement device 30 by which the stop element 24 is move able for example against a spring force of a reset spring temporarily and can move away from a respective cutting element in this manner. Thus it is appreciated that this escapement should only be performed when the stop element 24 has performed it's primarily function of reacting cutting forces into the feed arrangement 12.

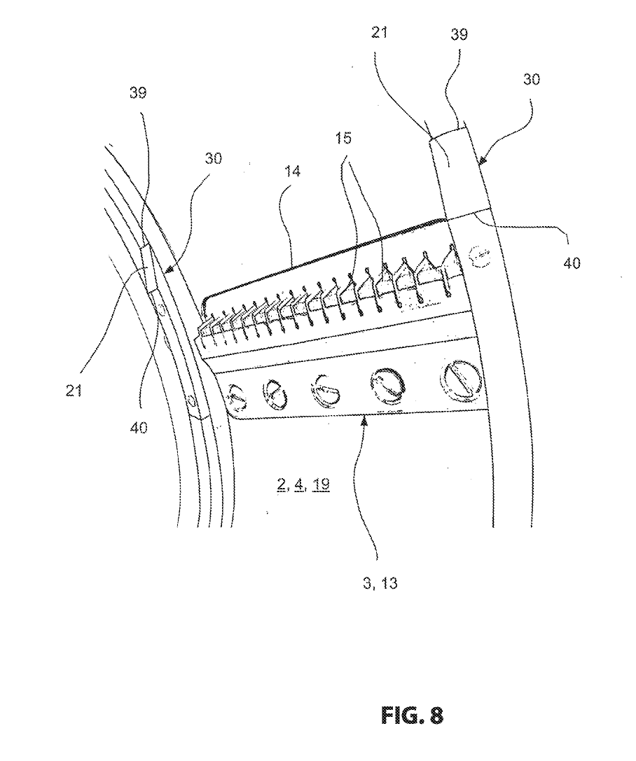

In order to support the stop element 24 the feed arrangement 12 has a short cantilever plate 41 in the illustrated embodiment by which the stop element 24 is supported laterally adjacent to the pass through opening 26 of the feed arrangement 12. In order for the stop element 24 to be able to escape parallel to the feed direction 7 the cantilever plate 41 has a cut out 28 on a back side. The cut out facilitates that the stop element 24 can exit from the back side of the cantilever plate 41 and facilitates a movement relative to the remaining feed arrangement 12 for the stop element 24. A described displacement arrangement 30 can be derived in particular from FIG. 8. The displacement arrangement 30 described there in includes 2 opposite inlet portions 21 which are arranged at opposite sides of the respective cutting element 3. The inlet portions 21 are configured wedge shaped so that they can displace a stop element 24 that collides with the displacement arrangement 30 particularly easily. Thus it is appreciated that a pointed end 39 of the respective inlet portion 21 contacts the stop element 24 when the illustrated displacement arrangement 30 engages a stop element 24. Due to further movement of the cutting arrangement 2 relative to the feed arrangement 12 or the stop element 24 the inlet portions 21 are then run further along the stop element 24. As soon as the stop element 24 has arrived at an end 40 of a respective inlet portion 21 it has been displaced at least far enough so that the cutting element 3 that is formed by a cutting box 13 in this embodiment can be run past the stop element 24 without colliding. As soon as the cutting element 3 has passed the stop element 24 the displacement arrangement 30 terminates which is implemented in that a recess is arranged laterally adjacent to the cutting element 3 wherein the recess enables the stop element 24 to transition back into an extended position. In this extended position the stop element 24 is configured again to support the food product to be cut up and an end section of the food product which shall be cut up during the subsequent contact with a cutting element 3.

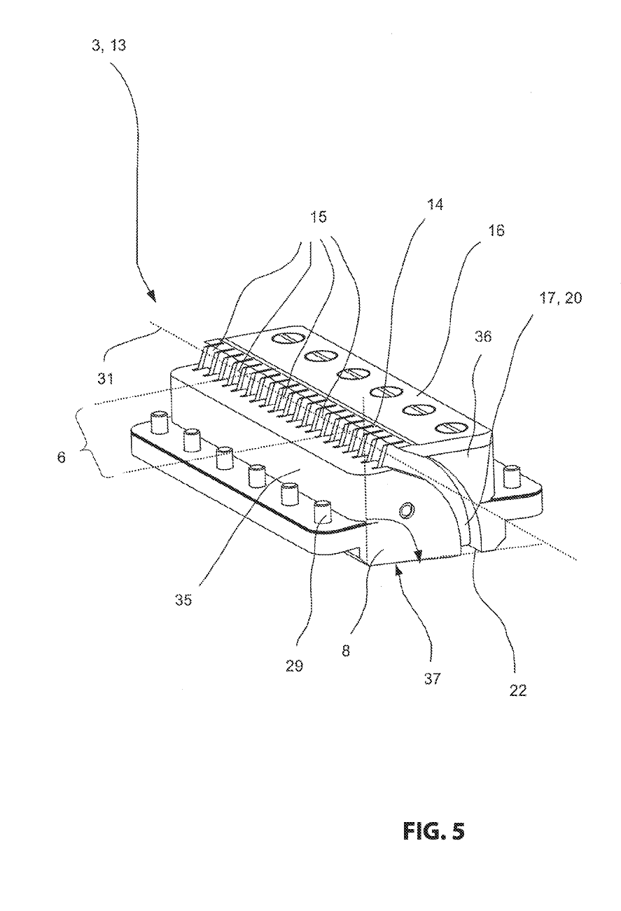

The cutting arrangement 2 includes a cutting element carrier 4 which is formed herein by a cutting disc 19. The cutting disc is configured circular wherein a thickness of the cutting disc 19 is much less than its diameter. The cutting arrangement 2 includes a plurality of cutting element 3 on its cutting element carrier 4. The cutting elements 3 are respectively configured as cutting cassettes 13. The cutting cassettes 13 are subsequently describe in detail and can be derived in particular from FIGS. 5-7. The cutting boxes 13 radially arranged on the cutting disc 19 so that a longitudinal axis 31 of a respective cutting box 13 is oriented in a direction of a center point of the cutting disc 19. The cutting boxes 13 are configured to cut a plurality of portions from the food product simultaneously in a single pass along the food product to be cut up.

Furthermore the cutting boxes 13 are configured to deflect the individual portions while they are cut off from the uncut food product and to impart a desired movement direction upon the portions. In order to operate the cutting arrangement 2 the cutting element carrier 4 is rotated about a drive axis 10 together with the cutting cassettes 13 arranged thereon, wherein the drive axis 10 is oriented parallel to the feed direction 7 of the food product. This way a cutting plane is generated at the food product wherein the cutting plane is in turn oriented perpendicular to the feed direction 7.

In particular it is possible to feed the individual portions that are generated by the cutting elements 3 in a controlled manner to the length cutting arrangement 5 which is arranged in the feed direction 7 on a side of the cutting arrangement 2 that is oriented away from the food product. The length cutting arrangement 5 in the illustrated embodiment is configured rotate able and includes a length cutting disc 27. The length cutting disc 27 is configured circular like the cutting disc 19 of the cutting arrangement 2. A diameter of the length cutting disc 27 is slightly smaller than a diameter of the cutting disc 19 of the cutting arrangement 2. A drive axis 11 of the length cutting arrangement 5 is identical to the drive axis 10 of the cutting arrangement 2. The length cutting arrangement 5 includes a plurality of length cutting edges 18 which are radially arranged on the length cutting disc 27. This means that a respective longitudinal axis 32 of a length cutting edge 18 is oriented so that it intersects a center axis of the length cutting edge 27. Cutting edges of the length cutting edges 18 are arranged in a common cutting plane 9 of the length cutting arrangement 5. Thus the cutting plane 9 of the length cutting arrangement 5 is arranged parallel to a cutting plane of the cutting arrangement 2 or of the cutting edges of the cutting elements 3.

In the illustrated embodiment the cutting disc 19 and the length cutting disc 27 of the cutting arrangement 2 or of the length cutting arrangement 5 are positioned relative to one another so that they are on the one hand side arranged directly behind one another and on the other hand side rotate able about the same drive axis 10, 11. During operations of the device 1 according to the invention the cutting disc 19 of the cutting arrangement 2 is rotated about its drive axis 10, while the length cutting disc 7 of the length cutting arrangement 5 is rotated about its drive axis 11. The two drive axes 10, 11 coincide in the illustrated embodiment. Furthermore the drive axis 10, 11 are oriented parallel to the feed direction 7 as described supra. The cutting arrangement 2 and the length cutting arrangement 5 are rotated about their drive axes 10, 11 in opposite directions, this means that the length cutting arrangement 5 is rotated clock wise relative to the feed direction 7 whereas the cutting arrangement 2 is rotated counter clockwise. This geometric arrangement of the feed arrangement 12, the cutting arrangement 2 and the length cutting arrangement 5 causes the food product to be successively cut up in a direction perpendicular to its feed direction 7.

This has the effect that a cut surface of the food product is oriented at least essentially perpendicular to the feed direction 7. This is caused by the fact that the individual cutting elements 3 of the cutting arrangement 2 are supported in a cutting plane that is orthogonal to the feed direction 7. This cutting plane is parallel to a plane of the cutting disc 19. During a movement of a cutting element 3 along the uncut food product an end of the food product that is oriented towards the cutting arrangement 2 is cut off therefrom and sliced into portions. Thus a length of the uncut food product is continuously reduced whereas portions are simultaneously continuously formed. The individual portions are completed in that they are cut to length by the length cutting arrangement device 5. The individual portions are completed in that they are cut to length by the length cutting arrangement 5 after being separated from the food product and thus get their final shape. The cutting by the length cutting arrangement 5 thus represents a cut in a third linear independent cutting plane so that the device 1 according to the invention facilitates defining the portions in their 3 dimensions (length, width and height). As already described supra the cutting elements 3 are respectively formed in the instant embodiment by a cutting cassette 13. From FIGS. 5-7 it is evident in particular in which way a cutting cassette of this type can be configured. The illustrated cutting cassettes respectively include a transversal cutting edge 14 and a plurality of longitudinal cutting edges 15. The longitudinal cutting edges 15 are arranged perpendicular to the transversal cutting edge 14 so that a cutting plane 16 of the transversal cutting edge 14 is oriented perpendicular to the individual cutting planes 17 of the respective longitudinal cutting edges 15. The cutting edges 15 protrude beyond the transversal cutting edge 15 of the movement direction of the cutting box 13 so that the longitudinal cutting edges 15 and thereafter the transversal cutting edge 14 comes into cutting contact with the food product first when the cutting box 13 comes in contact with the food product to be cut up.

The longitudinal cutting edges 15 are respectively arranged parallel to each other and oriented relative to each other so that they penetrated into the uncut food product simultaneously. It is appreciated that a plurality of initial strip shaped portions is generated simultaneously when the cutting box 13 is run along a cutting surface of the food product to be cut once, wherein a respective portion is defined in its width by 2 adjacent longitudinal cutting edges 15 an in its height by the transversal cutting edge 14. This applies initially for a center portion 6 of the cutting box 13 which is typically in full contact with the food product. This means that the food product is cut up at least by the center portion 6 of the cutting box 13 typically by the entire cutting box 13 so that the generated portions respectively have at least 3 cut sides which are caused by a cutting engagement with the longitudinal cutting edges 15 and the transversal cutting edge 14. Put differently a cutting engagement is not performed in the illustrated embodiment through which a strip shaped portion is only formed by a single longitudinal cutting edge 15 and the transversal cutting edge 14 at least in the center portion 6 of the cutting box. While running the cutting box 13 along the food product the portions that are being made are introduced into the cutting box 13 due to the movement of the respective cutting box 13 relative to the food product. Within the cutting box 13 the portions are then deflected by support channels 20. A respective support channel 20 is laterally defined between 2 adjacent longitudinal cutting edges 15. Furthermore a support channel 20 is defined in downward and upward direction geometrically by wall elements 35, 36 of the cutting box 13. This has the consequence that the portions that are being made are deflected within the cutting box 13 by a deflection angle 8 since they do not have any other movement option. Put differently the portions that are being made are forced in a predetermined direction within the cutting box 13 and within the respective support channel 20. The support channels 20 respectively have a flattened length of approximately 20 cm. The support channels 20 respectively have a width of 1.0 cm so that a ratio of width to flattened length of a respective support channel 20 is 0.083. In the illustrated embodiment the deflection angle 8 is approximately 90° so that the portions have a movement direction after being cut off from the cutting surface of the food product and after exiting on a back side 37 of the cutting box 13 wherein the movement direction is at least essentially parallel to the feed direction 7 of the food product. This way the individual portions can be fed to the length cutting arrangement 5 described in a particularly simple manner since the length cutting arrangement adjoins at the side of the cutting arrangement 2 which is oriented away from the food product in the feed direction 7 of the food product. The support channels 20 consequently have a circumference of approximately 48 cm and a radius of approximately 7.6 cm. Thus a camber of the support channels 20 is approximately 0.3 and is therefore in an advantageously range between 0.1 and 0.3.

The cutting boxes 13 are respectively connected at the cutting element carrier 4 by a plurality of attachment elements 29. The cutting box 13 has an opposite cutting edge 22 on a back side 27. The opposite cutting edge 22 is configured to cooperate with the length cutting edges 18 of the length cutting arrangement 5. This is implemented in that the individual portions which shall be cut to length by the length cutting edges 18 are supported at the opposite cutting edge 22 so that a respective portion of the cutting force which is imparted by the respective cutting edge 18 onto the portion cannot move out. Since the length cutting edges 18 and the opposite cutting edges 22 of the cutting boxes 13 are run past each other at a minimal distance, there is a risk that a collision occurs between a length cutting edge 18 and an opposite cutting edge 22 due to fabrication tolerances during a movement of the length cutting arrangement 5 and the cutting arrangement 2 relative to each other.

In order to prevent this there is an option to change a position of a respective opposite cutting edge 22 relative to the length cutting arrangement 5. A change of this type can be accomplished in a simple manner in that an attachment of the respective cutting edge 13 at the cutting element carrier 4 is provided by spacer elements so that a position of the respective cutting box 13 is adjustable relative to the cutting disc 19 of the cutting arrangement 2. This way it is possible to adjust a cutting box 13 and consequently its opposite cutting edge 22 with respect to its position parallel to the feed arrangement 7 of the food product so that a distance between the opposite edge 22 and the length cutting edges 18 of the length cutting arrangement 5 is adjustable in an optimum manner.

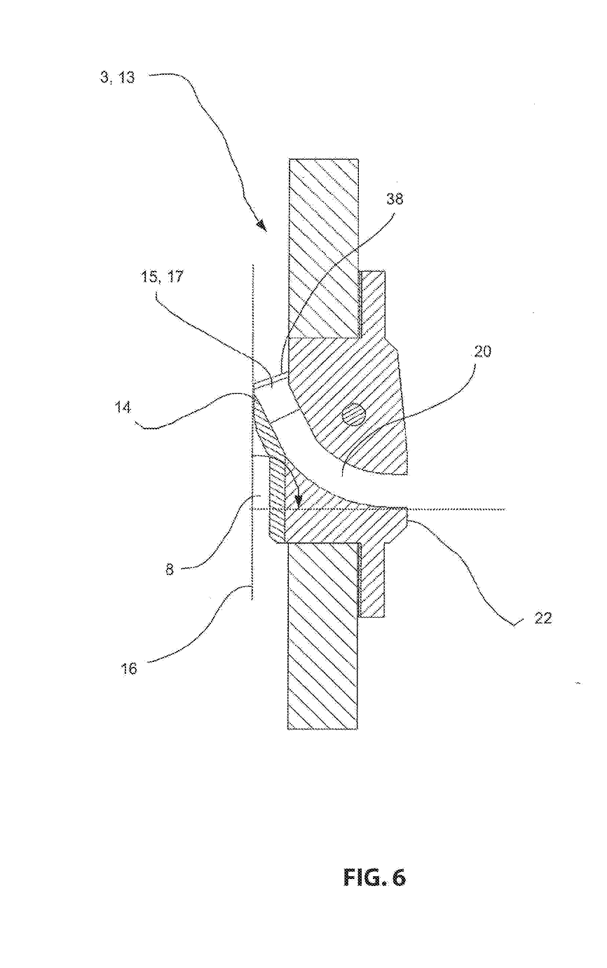

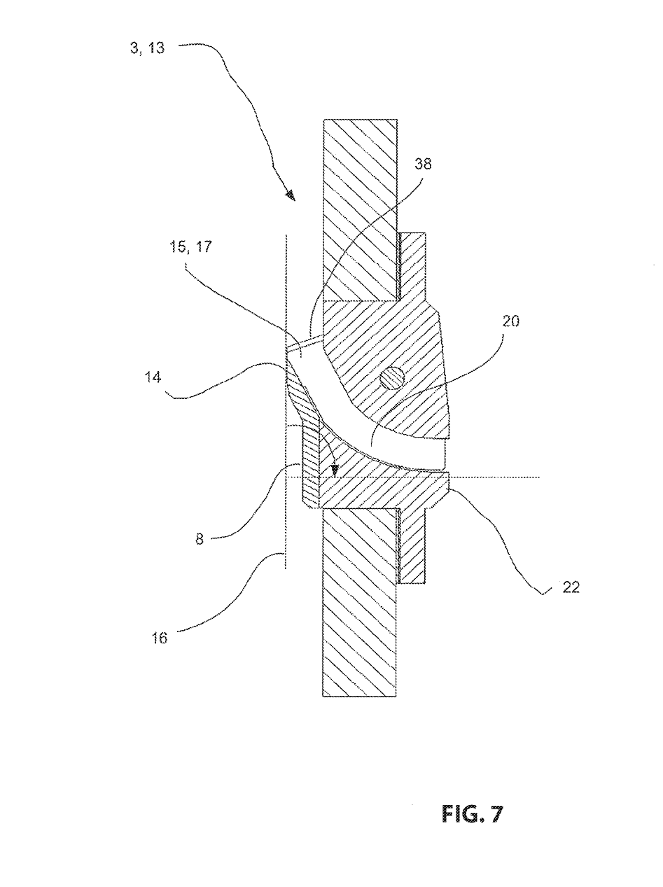

FIGS. 6 and 7 illustrate 2 alternative embodiments of longitudinal cutting edges 15 of a cutting box 13. In a first variant that is illustrated in FIG. 6 the longitudinal cutting edges 15 respectively have a small length so that the longitudinal cutting edges starting from a cutting edge 38 only extends into the associated support channel 20 by a small amount. This has the consequence that the portions that are laterally cut by the longitudinal cutting edges 15 can come in direct contact with each other within the support channel 20 behind the longitudinal cutting edges 15. This contact is without problems in particular when the food product to be cut up is provided in a partially frozen or completely frozen condition. In these cases the individual portions do not tend to adhere to each other and to form a conglomerate. When a soft food product is to be cut by the device 1 it is helpful to use cutting cassettes 13 according to another embodiment. This embodiment is illustrated in an exemplary manner in FIG. 7. It is visible in this variant that the longitudinal cutting edges 15 respectively extend over and entire length of its support channels 20. This has the consequence that the portions that are formed by the cutting cassette remain insulated from each other over an entire length of the support channels 20 so that a direct contact of the individual portions within the cutting cassette 13 is prevented.

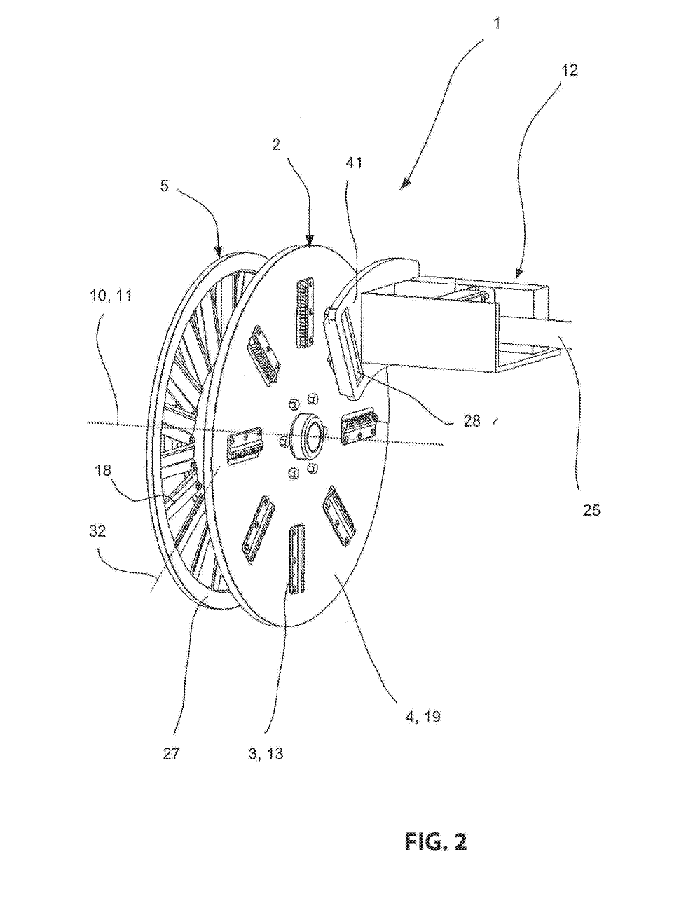

In particular FIGS. 1 and 2 illustrate the device according to the invention respectively in an exploded view. Therefore the individual components of the device 1 are not directly adjacent to each other in this embodiment. It is appreciated that the features that are described supra in a context with the embodiment do not have to be associated with each other. Instead it is also conceivable to implement the individual features independently from each other in a device according to the invention as deemed fit by a person skilled in the art.

### REFERENCE NUMERALS AND DESIGNATIONS

1 device
2 cutting arrangement
3 cutting element
4 cutting element carrier
5 length cutting arrangement
6 center portion
7 feed direction
8 deflection angle
9 cutting plane
10 drive axis
11 drive axis
12 feed arrangement
13 cutting box
14 transversal cutting edge
15 longitudinal cutting edge
16 cutting plane
17 cutting plane
18 length cutting edge
19 cutting disc
20 support channel
21 inlet portion
22 opposite cutting edge
23 fixing arrangement
24 stop element
25 feed plunger
26 pass through opening
27 length cutting disc
28 recess
29 attachment element
30 displacement arrangement
31 longitudinal axis
32 longitudinal axis
33 telescope element
34 contact plate
35 wall element
36 wall element
37 back side
38 cutting edge
39 end
40 end

What is claimed is:

1. The present invention relates to a method for cutting a food product, in particular a food product strand, into portions, in particular into strips or cubes, comprising the following method steps:
a) The food product is advanced to a cutting device (2) by means of an advancing device (12).
b) Successive portions are cut off from the food product from an end of the food product which faces the cutting device (2) by means of at least one cutting element (3), wherein the cutting element (3) is guided by means of a disc-shaped cutting element carrier (4), on which the cutting element (3) is arranged, wherein the cutting element carrier (4) is rotated about a drive axis (10) which is oriented at least substantially parallel to an advancing direction (7) of the advancing device (12).
c) During one-time guiding of the cutting element (3) past the end of the food product, a multiplicity of strip-shaped portions are produced. In order to provide a method, by means of which it is possible to produce cube-shaped portions in a particularly rapid manner, according to the invention the portions which are being produced are cut to size by means of at least one length cutting device (5) after the cutting by means of the at least one cutting element (3). The present invention further relates to a corresponding device.
characterized in that

2. The method according to claim 1, characterized in that the food product is moved towards the cutting arrangement (2) in increments.

3. The method according to claim 1 or 2, characterized in that portions that are being made are being deflected during cutting so that a movement direction of a respective portion includes at least a movement component that is parallel to a feed direction (7) of the food product, wherein the portions are advantageously deflected by the cutting arrangement.

4. The method according to claim 3, characterized in that the portions are only cut to length after being deflected by the at least one length cutting arrangement (5), wherein a cutting plane (9) of the length cutting arrangement (5) is advantageously oriented perpendicular to the feed arrangement (7) of the food product.

5. The method according to one of the claims 1-4, characterized in that the at least one length cutting arrangement (5) is rotated about a drive axis (11), advantageously about the same drive axis (10) about which the cutting element carrier (4) is rotated, wherein the length cutting arrangement (5) is advantageously configured disc shaped.

6. The method according to claim 5, characterized in that the length cutting arrangement (5) and the cutting arrangement (2) are rotated in opposite directions.

7. The method according to one of the claims 1-6, characterized in that cutting the food product includes measuring at least one residual section of the food product and adapting a feed of the food product based on captured data so that an end piece of the food product is cut by a last cut of the cutting arrangement (2) at least essentially completely, advantageously cut completely.

8. A device (1) for cutting a food product in particular a food strand in portions, in particular in strips or cubes, the device comprising
at least one feed arrangement (12), and
at least one cutting arrangement (2),
Wherein the food product is feed able in feed direction (7) towards the cutting arrangement (2) so that successive portions are cut able by the cutting arrangement (2) from an end of the food product that is oriented towards the cutting arrangement (2),
Wherein the cutting arrangement (2) includes at least one cutting box (13) which includes at least one transversal cutting edge (14) and a plurality of longitudinal cutting edges (15),
Wherein the transversal cutting edge (14) is arranged in a first cutting plane (16) which is oriented at least essentially parallel to a cutting surface of the food product, wherein the longitudinal cutting edges (15) are respectively arranged in cutting planes (17) which are not oriented in parallel with the cutting plane (16) of the transversal cutting edge (14), so that the food product is cut able in at least 2 cutting planes (16, 17) that are oriented in different direction, wherein the cutting box (13) is rotate able about a drive axis (10) which is oriented at least essentially parallel to the feed direction (7), characterized by at least one length cutting arrangement (5) by which portions cut by the cutting arrangement (2) are cut able to length.

9. The device (1) according to claim 8, characterized in that the length cutting arrangement (5) is configured as a rotate able length cutting disc (27) which advantageously includes a plurality of length cutting edges (18), wherein a drive axis (11) of the length cutting arrangement (5) is advantageously oriented parallel to the drive axis (10) of the cutting arrangement (2), further advantageously the drive axes (10, 11) of the length cutting arrangement (5) and of the cutting arrangement (2) coincide.

10. The device (1) according to claim 8 or 9, characterized in that the cutting planes (17) of the longitudinal cutting edge (15) are oriented at least essentially perpendicular to the cutting plane (16) of the transversal cutting edge (14), wherein advantageously all cutting boxes (13) include a transversal cutting edge (14) that is oriented parallel to the cutting surface of the food product and a plurality of the additional longitudinal cutting edges (15) that are perpendicular to the transversal cutting edge (14) and parallel to each other and adjacent to each other.

11. The device (1) according to one of the claims 8-10, characterized in that the the cutting arrangement (2) advantageously includes at least one cutting box (13), at least one support channel (20) by which a portion that is being made is deflectable so that a movement direction of the respective portion after deflection includes at least a movement component that is perpendicular to the feed direction (7) of the food product.

12. The device (1) according to claim 11, characterized in that support channel has a circular arc shape, wherein the circular arc advantageously extends over a deflection angle (8) of at least 70°, advantageously at least 80°, further advantageously at least 90°.

13. The device (1) according to one of the claims 8-12, characterized in that the cutting arrangement (2) includes at least one opposite cutting edge (22) on a side that is oriented away from the food product wherein the opposite cutting edge is configured to cooperate with the length cutting arrangement (5), wherein a distance between the opposite cutting edge (22) and the length cutting arrangement (5) is variable.

14. The device (1) according to one of the claims 8-13, characterized by at least one stop element (24) which protrudes beyond the cutting plane (14) of the transversal cutting edge in the feed direction (7) so that a section of the food product that is being cut off is at least partially supportable by the stop element (14).

15. The device (1) according to claim 14, characterized in that the cutting arrangement (2) includes at least one displacement arrangement (30) by which the stop element (24) is displace able so that a collision between the stop element (24) and the cutting box (13) is avoid able.
